(19) United States
(12) Patent Application Publication
(10) Pub. No.: US 2009/0259570 A1
(43) Pub. Date: Oct. 15, 2009

(54) METHOD OF INVENTORYING AN ELECTRICALLY POWERED BEVERAGE BREWER

(76) Inventor: Zbigniew G. Lassota, Long Grove, IL (US)

Correspondence Address: James W. Potthast;Potthast & Associates, 10606 Deerpath Road, Woodstock, IL, 60098, US

(21) Appl. No.: 12/252,635

(22) Filed: Oct. 16, 2008

Related U.S. Application Data
(62) Division of application No. 12/247,485, filed on Oct. 8, 2008.
(60) Provisional application No. 60/998,739, filed on Oct. 12, 2007.

(51) Int. Cl. G06Q 10/00; G06Q 50/00

(52) U.S. Cl. 705/28

(57) ABSTRACT

A method of inventorying electrically powered beverage brewers (104) includes the steps of making an electrically powered beverage brewer model (104) that is capable of operating with either single-phase electrical power or two-phase electrical power, without alteration after completion of manufacture, though selective use of a power connection adapter (112), and assigning only a single one of one of (a) a model number, (b) an inventory stock number or (c) a stock keeping unit number or (d) any inventory control number that uniquely distinguishes the model without reference to the type of power required and using at least one of the numbers for at least one of (a) inventory control, (b) ordering, (c) selecting a warehouse storage location.

### CROSS-REFERENCE TO RELATED APPLICATION

This application is a divisional of, and claims the benefit under 35 U.S.C. 120 of, application Ser. No. 12/247,485, filed Oct. 8, 2008 which, in turn, claims the benefit under 35 U.S.C. 119(e) of provisional patent application No. 60/998,739 of the present inventor filed Oct. 12, 2007, and entitled “Electrically Powered Beverage Brewer, Power Connection Adapter and Methods of Inventorying, Making and Installing an Electrically Powered Beverage Brewer”, all of which are hereby incorporated by reference.

### BACKGROUND OF THE INVENTION

1. Field of the Invention

This invention relates to methods for making and inventorying same electrical beverage brewers.

2. Discussion of the Prior Art

Commercial beverage brewers of the type that brew one-half to three gallons of beverage per brew cycle and their inner workings are well known. information concerning the structural, mechanical and other details of the conventional components of coffee brewers and the like, then reference should be made to one or more of U.S. patents of the present inventor including U.S. Pat. No. 5,000,082, entitled “Beverage Maker And Method Of Making Beverage”, issued Mar. 19, 1991; U.S. Pat. No. 5,331,885, entitled, “Semiautomatic Beverage Maker And Method”, issued Jul. 26, 1994; U.S. Pat. No. 5,943,944, issued Aug. 31, 1999 entitled, “Semiautomatic Beverage Maker and Method”; and U.S. Pat. No. 6,148,717, issued Nov. 21, 2000, entitled, “Beverage Maker with Intermittent Beverage Liquid Dispenser and apparatus and Method for Uniform Contact of Brew Ingredient with Brew Water” of the present inventor and the patents cited therein, all of which are incorporated herein by reference.

Such brewers have electrical heating elements for heating dispense water contained in hot water tanks or the like that is selectively passed to a brew basket containing beverage ingredient, such as ground coffee beans, tea leaves, ground tea leaves, cocoa, etc. The hot water mixes with and partially extracts elements of the ingredient that are dissolved or mixed with the water to make the freshly brewed beverage.

Generally, the electrical heating elements of many commercial brewers in use are powered by two-phase, 240-VAC to 240 VAC. electrical power from a local public utility. However, many of the brewers are powered by single-phase 120-VAC electrical power. The internal wiring for operation of the heating element using single-phase, 120-VAC power is different from the internal wiring for operation using two-phase, 240-VAC power. Almost all of the electrical power for the brewing operation is applied to the electrical heating elements within the hot water tank to heat the water to the desired hot temperature for brewing.

Often, two electrical heating elements are used to provide improved reliability through redundancy. When the heating elements are powered by two-phase, 240-VAC power, one heating element is connected between a neutral line, commonly designated by the letter N, and one of the two hot lines, commonly referred to as L1 and L2, while the other heating element is connected between the neutral line and the other one of the hot lines, L1 and L2. When the heating elements are powered by single-phase, 120-VAC power, if two heating elements are provided, both of the heating elements are connected in parallel between the one hot line, L, and the neutral line, N.

Also, the standard electrical power cord and plug for connecting to a standard 120-VAC wall receptacle is different from the standard power cord and standard plug used for connecting to a standard 240-VAC wall receptacle. The electrical cord for 120-VAC use has only three wires: one hot wire, L, one neutral wire, N, and one ground wire, G and the plug has only three male connector members, or prongs, respectively attached to the three wires of the cord. The male connectors, or prongs, are in a particular configuration and arranged in a particular pattern that is unique to single-phase, 120-VAC power and are connection incompatible with, and will not fit into, a two-phase, 240-VAC wall outlet, or receptacle, that has four female connection elements.

On the other hand, the electrical cord for two-phase, 240-VAC use has four wires: a first hot wire, L1, one neutral wire, N, one ground wire, G, and a second hot wire, L2. The plug carries four male connector members respectively attached to the four wires of the cord. The prongs are in a particular configuration and arranged in a particular pattern that is unique to two-phase, 240-VAC power and is not connection compatible with, and will not fit into, a single-phase, 120-VAC wall outlet that has three female connection elements.

The standards for the different types of plugs and receptacles for single-phase and two-phase sources of power are established by such organizations as the National Electrical Manufacturers Association (NEMA) and reference to their standards should be made for any detailed information about the shapes and sizes and arrangements of the various connection elements in the different types of power connectors plugs and receptacle referred to herein.

A single-phase brewer may be converted at the warehouse to a two-phase brewer by appropriate changing of the wiring and the power cord and plug. Likewise, a two-phase brewer may be converted at the warehouse to a single-phase brewer. However, this is only possible if work facilities and trained personnel are available at the warehouse or other inventory storage location to make such wiring, power cord and plug changes. Such ad hoc changes to the brewers in inventory take time and money to make. Once the changes are made, recertification by quality control may be required to insure that the changes were correctly made. In general, such an ad hoc approach to changing brewers in inventory for compatibility with different types of power sources results in greater costs of labor, book keeping, inventory keeping, spare parts maintenance at the warehouse, etc., thereby making this approach less than satisfactory.

Another approach is to ship a brewer to a customer location at which it is incompatible with the power source on site, but then converting the brewer in the field to become compatible. However, this approach suffers from the same problems as in-warehouse alterations. Moreover, there are additional costs of labor and time of trained field technicians and the costs of travel. Changing power compatibility in the field also suffers from the disadvantages of a lengthier installation and resultant greater disruption of business on-site during normal hours of operation.

Additional problems may arise with known beverage brewers and the way they are inventoried and installed. Even with complete inventories of both types of brewers being maintained, it is not uncommon for a purchaser unfamiliar with the particular type of power available at the installation site to order the incorrect power version of the model. When this happens, the model must be returned once the installer arrives and determines the error, or the installer must also be a trained technician capable and prepared to convert the brewer from one power version to the other. Consequently, it is common practice to have a preliminary inspection of the premises before installation to confirm the information provided by the purchaser even when the purchaser indicates which power option is desired. This inspection increases the delay in installation and, of course, adds to the total cost of the entire installation process.

Accordingly, many manufacturers make two different versions of each beverage brewer that they make: a two-phase version, such as shown in the PRIOR ART drawing of FIG. 1, and a separate, single-phase version shown in FIG. 2. Aside from any internal wiring differences, the two-phase version of FIG. 1 has a standard two-phase, power cord and plug. Accordingly, in order to maintain a complete inventory, different brewer models, each with their own unique inventory control number, order number, or stock keeping brewer (SKU) number, that are identical in all respects except for being adapted for operation with one or the other of the two different types of electrical power, must be maintained in inventory. In such case, if a two-phase version of a brewer model is available in inventory, it cannot be used to fill an order for the single-phase version, and vice versa. Instead, the brewer which has been ordered cannot be shipped from inventory but must be back-ordered leading to delay and often customer dissatisfaction.

### SUMMARY OF THE INVENTION

It is therefore an object of the present invention to provide method of inventorying a electrically powered beverage brewer that overcome the disadvantages of known methods noted herein.

This objective is achieved in part by providing a method of inventorying electrically powered beverage brewers, by performing the steps of making an electrically powered beverage brewer model that is capable of operating with either single-phase electrical power or two-phase electrical power, without alteration after completion of manufacture, though selective use of a power connection adapter, and assigning only a single one of one of (a) a model number, (b) an inventory stock number or (c) a stock keeping unit number or (d) any inventory control number that uniquely distinguishes the model without reference to the type of power required, and using at least one of the numbers for at least one of (a) inventory control, (b) ordering, (c) selecting a warehouse storage location.

Preferably, the power connector adapter is a plug adapter with three male connectors for connection with a standard single-phase, electrical, AC, power supply receptacle and four female connectors for connection to four male connectors of a standard two-phase, AC, power plug. The beverage brewer includes two electrical, hot water, heating elements commonly connected to a neutral male connector of the two-phase power plug and respectively connected to two power carrying male connectors of the power plug. The adapter carries means for permanently attachment to the power plug, and the method includes the step of packaging the adapter together with the beverage brewer.

Preferably, the brewer model has a two phase power capability and has an attached two phase power connector plug. The brewer model may include a non-connected two-phase to one-phase power plug adapter selectively connectable to the two phase power plug for conversion for use with single phase power. The brewer model has two heating elements and preferably has a switch for selectively connecting the heating elements to either the same side of a two phase power line or to opposite sides of the two-phase power line.

### BRIEF DESCRIPTION OF THE DRAWINGS

The forgoing advantages and objectives of the invention will be described in greater detail and further features will be made apparent from the following description of the preferred embodiment of the invention that is given with reference to the several views of the drawing, in which:

FIG. 1 is a functional block diagram of one PRIOR ART installation assembly in which an electrically powered beverage brewer internally wired for receipt of 240-VAC electrical power is connected to a wall mounted, 4-prong receiving, 240-VAC receptacle though a 4-prong, 240-VAC power plug connected to a distal end of a four-lead power cable, or power cord;

FIG. 2 is a functional block diagram of another PRIOR ART installation assembly in which an electrically powered beverage brewer internally wired for receipt of 120-VAC electrical power is connected to a wall mounted, 3-prong receiving, 120-VAC receptacle through a 3-prong, 120-VAC power plug connected to a distal end of a three-lead power cord;

FIG. 3 is a flow chart illustrating a PRIOR ART method of making, inventorying, shipping and installing an electrically powered beverage maker at a customer site provided with a wall mounted, 120-VAC, 3-prong receiving, power receptacle in which separate inventories of different power capabilities are maintained;

FIG. 4 is a flow chart of another PRIOR ART method of making, inventorying, shipping and installing beverage brewer models in which only two-phase brewers are produced and are converted to be compatible with a single-phase power source at the customer site, as needed;

FIG. 5 is a functional block diagram illustrating the use of a two-phase to single phase, or a 4:3, power connector, plug adapter of the present invention to connect a 3-receptor connector, power plug receptacle of a source of single-phase, 120-VAC power to an electrically powered brewer having only a two-phase, 4-prong, 240 volt power plug; and

FIG. 6 is a functional block diagram of an electrically powered beverage brewer constructed in accordance with the present invention;

FIG. 7 is a side view of the interlocked plug and adapter of FIG. 5 with a portion broken away to illustrate an interlock; and

FIG. 8 is a flow chart of a method of making, shipping and installing the electrically powered beverage brewer of FIG. 3 in accordance with the methods of the present invention.

### DETAILED DESCRIPTION

Referring to FIG. 1, a functional block diagram of a PRIOR ART beverage brewer 10 is seen in association with a two-phase source of power 12, such as may be provided by a local electrical power company or by a private source of electrical power. The two phase source of electrical power 12 has four leads but power is basically, or essentially, provided on only three of the leads: a power lead, or hot lead, 14, designated L1 carrying a generally alternating, sinusoidal voltage that fluctuates relative to a neutral lead 16, designated N, that is generally at approximately zero volts; and another power lead 20, designated L2, that also carries an alternating, sinusoidal voltage relative to the ground lead 18. The sinusoidal voltages on the two lot leads, L1 and L2 are equal in voltage magnitude but are 180-degrees out of phase. The magnitude of the voltage is approximately 104-120 VAC. Accordingly, the magnitude of the voltage difference between them is approximately 208-240 VAC. The fourth lead 18, designated G, but is connected to earth ground, usually through a connection with metal wiring conduit, and at ground zero volts. The ground lead 18 is generally connected to ground the metal frame or housing of the brewer and is required for purposes of safety even though it carries no power.

These four leads of the two-phase electrical power source 12 are connected to input terminals of a standard, two-phase, power receptacle 22 mounted flush to a wall 24 at the customer site. The two-phase beverage brewer 10 has a power cord assembly with an elongate power cable 26 having one end connected to an internal power terminal strip (not shown) protectively contained within the brewer 10 and an opposite end connected to a standard two-phase power plug 28. The two-phase cable has four lines 30, 32, 36 and 38 corresponding to the first power line L1, the neutral line N, the ground line G and the second power line L2, respectively. These four lines are respectively connected within the plug body to four male connectors, or prongs, 40, 42, 44 and 46.

During installation, the four prongs 40, 42, 44 and 46 are respectively connectively inserted into four mating female connectors, or female connection elements, at the front of the two-phase power receptacle 22 that, in turn, are respectively connected to the four lines 14, 16, 18 and 20 of the two-phase power source 12. The four prongs are keyed by shape and position to prevent the plug from being incorrectly inserted into a two-phase power receptacle. Accordingly, once the connection between the plug 28 and the receptacle 22 is made, the four lines of the two-phase power source 12, lines 14, 16, 18 and 20, are connected, respectively, through the prongs 30, 42, 44 and 46 of the power plug 28 to the two-phase power cable leads 30, 32, 34 and 36, respectively. The power cable leads are appropriately connected within the brewer 10 to power heating elements and other brewer elements.

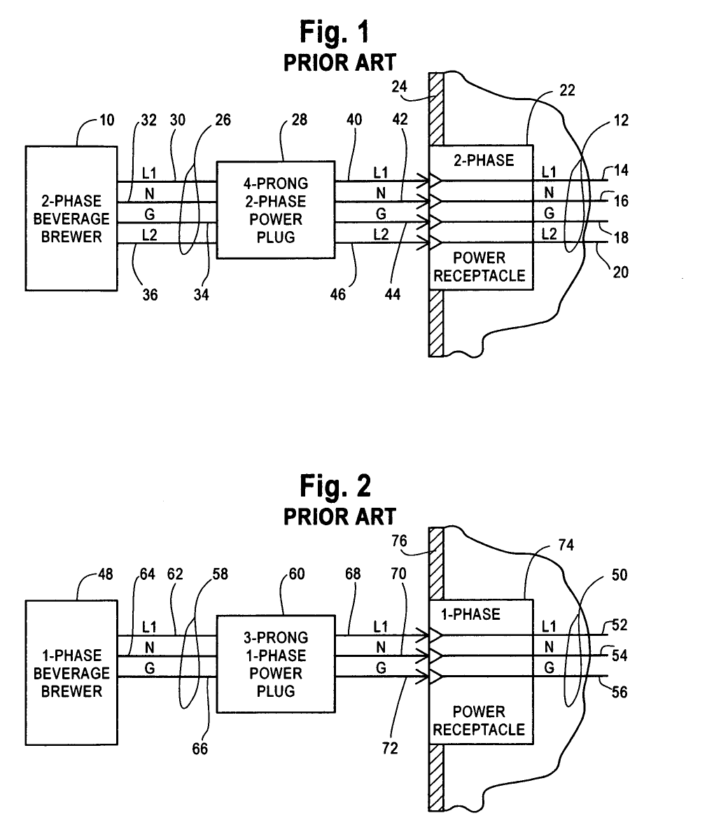

Referring now to FIG. 2, another beverage brewer 48 is shown that is substantially the same model as the 2-phase beverage brewer 10 but which is internally wired to be powered only by a single-phase power source and is therefore referred to as a single-phase beverage brewer. The single phase brewer 48 is designed to be connected to a single-phase source of power 50 that has only three lines, a power line 52, designated L, a neutral line 54, designated N, and a ground line 56, designated G. The power line carries an alternating, sinusoidal voltage with a magnitude of 104-120 VAC relative to the neutral line 54 that is approximately at the same zero voltage as the ground line 56. As noted, the ground lead does not actually carry any power but is provided for purposes of safety to facilitate grounding of metal parts of the beverage brewers. Internally connected to the single-phase beverage brewer 48 is one end of a three lead, single-phase, power cable 58 the other end of which is connected internally to a three-prong, single-phase, power plug 60. The other end of the power cable 58 has three leads 62, 64 and 66 respectively designated L, N and G.

The three leads of the cable are respectively connected to three prongs 68, 70 and 72 of the single-phase power plug 60. The three prongs 68, 70 and 72 are adapted to be connectively received within three mating female connection elements of the single-phase power receptacle 74 that are, in turn, connected to the three single-phase lines 52, 54 and 56 of the single-phase power source 50. If the receptacle 74 is not mounted within a wall 76, then it is located at a receptacle end of an extension cord that, in turn, is connected to a wall power receptacle like that of receptacle 74. The prongs are keyed by shape and location to fit into the receptacle in a single way. When the connection between the plug 60 and the power receptacle 74 is made, lines 52, 54 and 56 become electrically connected to lines 62, 64 and 66, respectively.

Because of the differences in size, arrangement, shape and number prongs of the two-phase power plug 28 and the single-phase power plug 60, the two-phase power plug will not fit into and connect with a standard single-phase power receptacle and a single-phase power plug will not fit into and electrically connect with a two-phase power receptacle. It is not unusual for a customer ordering a beverage brewer to not know which type of power is available at the installation location. Accordingly, inspections are often performed by installation technicians before an order is placed to insure that the correct power version of the desired model is being ordered.

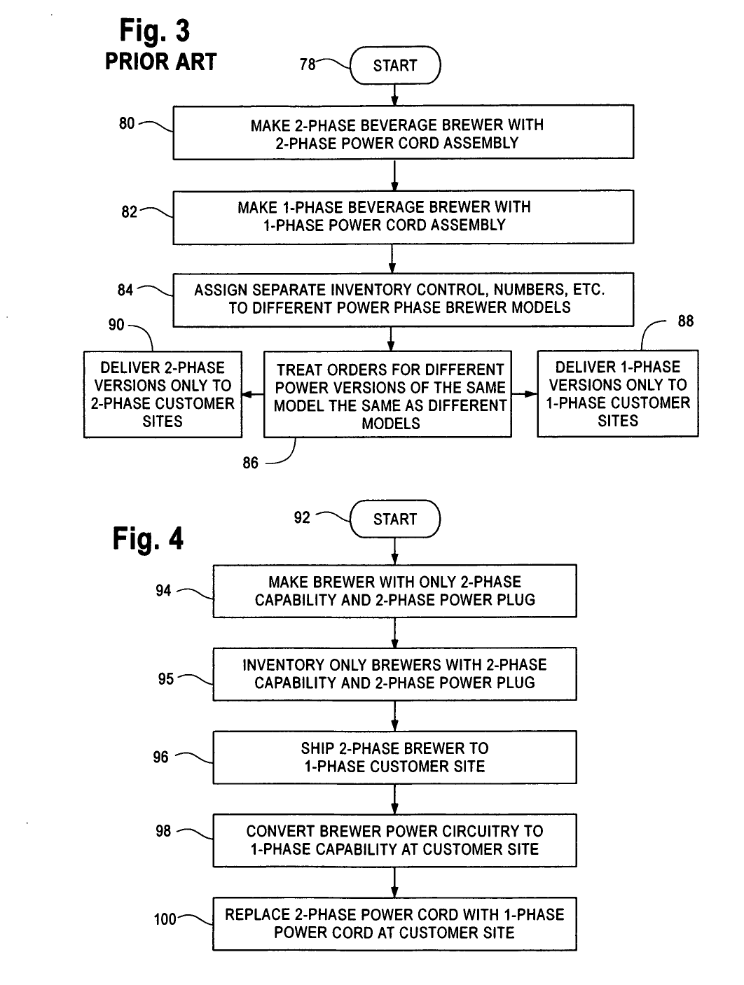

Thus, after start 78 of the PRIOR ART method of making and inventorying commercial beverage brewers shown in FIG. 3, two-phase beverage brewers are made with two-phase power cord assemblies in step 80 and single-phase beverage brewers are made with single-phase power cord assemblies in step 82. Then, in step 84, separate and distinct inventory control codes, model codes, stock keeping brewer (SKU) codes, or numbers, or the like are assigned to the two-phase versions of the brewer model that are different from the single-phase versions of the same brewer model. Thereafter the two different models are treated as if they were completely different from one another and not capable of being converted in the field as discussed above.

In step 86, orders for different power versions of the same model are treated the same way that they would be treated as if they were completely different models not capable of being converted in the field or the warehouse from one power version to another. If there are two-phase versions available, but no single-phase models available, when an order for a single-phase version comes in, the order cannot be delivered and delivery must wait until another single-phase version is manufactured, either by conversion in the warehouse or originally without conversion at the factory, and placed in inventory. In step 88, orders for single-phase versions of the model are sent to what are believed to be single-phase customer sites, and in step 90, two-phase versions of the model are delivered to what are believed to be two-phase customer sites. Two-phase versions of the models are not intentionally sent to single-phase power customer sites, and single-phase versions are not intentionally sent to two-phase power customer sites.

If, inadvertently, a beverage brewer model is delivered to an installation site that is a power version that does not match the type of power at the customer installation site, there are only two options. The common option is to return the incorrect power version of the brewer model and reorder the correct power version of the brewer model. This disadvantageously results in delay and additional paperwork expense and delivery expense for return shipping and reshipping. The other option is to have an installation technician convert the incorrect power version of the model that has already been delivered to the correct power version model. The capability to perform such conversions results in greater payroll expense for installation technicians to perform the needed work and for the additional administrative overhead and greater disruption to the business of the customer during a lengthier installation process. In addition, there is a risk that the conversion will not be correctly performed, for unlike production in a factory, there is no supervision or separate quality control or quality assurance.

This PRIOR ART technique is illustrated in the flow chart of FIG. 4 in which after the start 92, in step 94 a two-phase power version of a particular brewer model is manufactured and placed in inventory. After the two-phase version of the brewer model is ordered, it is delivered to the customer site in step 96. Presuming that only single-phase power is available at the customer site or the customer prefers to operate the brewer with a single-phase power source, in step 84, an installation technician begins the conversion by first converting the electrical heating elements to a single-phase option. With the single phase option, the electrical heating elements are connected in parallel between only one of the two power lines L1 or L2 and the neutral lead N. This conversion of the internal wiring to the single-phase option may be performed by changing wire terminal connections at a terminal block with screw connectors, making new connections with jumper leads or both.

Next, in step 100, the installation technician, presuming he has a single-phase power cord assembly, removes the two-phase power cord assembly and replaces it with a single-phase power cord assembly. The single-phase power cord is then plugged into a single-phase power receptacle, and any other installation procedures are performed to make sure the new power cord has been correctly installed so that power is, in fact being delivered to the correct power line within the brewer to which the heating elements are attached and that the brewer is otherwise operating correctly. Records must then be made of the conversion for billing and maintenance purposes.

Referring now to FIGS. 5, 6 and 7, the present invention overcomes the problems noted above with respect to the PRIOR ART methods of making, inventorying, delivering and installing commercial beverage brewer models having two different power versions but which are otherwise substantially identical. Simply, in accordance with the preferred embodiment of the present invention, all brewers of a given model are internally wired with respect to the electrical heating elements to operate off a two-phase, alternating, electrical power source and are provided with a standard two-phase electrical power cord assembly with a standard two-phase electrical connector plug specially adapted to mate only with a standard two-phase, electrical, plug receptacle either mounted in a wall or at the end of a two-phase electrical extension cord that is connected to a wall outlet.

In the event that the customer installation site does not have a suitable two-phase outlet that delivers two-phase power, a two-phase to single-phase electrical power plug adapter, or 2:1 phase adapter, is attached to the two-phase plug to enable electrical connection of the two-phase plug to a single-phase plug receptacle and a source of single-phase electrical power. This approach to the problems eliminates (a) the need for two separate power cord assemblies and the resultant extra costs and time involved in ordering, inventorying and installing two different power cord assemblies instead of only one, (b) the additional costs caused by separate record keeping and separate storage and inventorying of the same models of different power capabilities, (c) the need for advance inspections to determine or confirm the type of power available at a customer site before delivery, (d) the costs and delay of returning and reordering delivered models of the wrong power capability for the installation site and (e) the increased payroll and administrative costs and increased business disruption caused by changing power cord assemblies at a customer site after delivery of a model incapable of operating with the type of power available or at the warehouse.

Referring to FIG. 5, a preferred embodiment of a beverage brewer assembly 102 of the present invention is seen to include a two-phase powered beverage brewer model 104 with a two-phase, electrical power cord assembly 106. The power cord assembly 106 has a two-phase power cable, or cord, 108 having one end connected to deliver two-phase power to the beverage brewer model 104 and the other end connected to a standard, two-phase electrical power plug 110 adapted to fit into a standard, two-phase, electrical, power, connector receptacle. Completing the manufacture of the beverage brewer assembly 102 for use with a single-phase, electrical, power supply is a two-phase to single-phase, electrical power connection plug adapter 112 that is attached to the two-phase power plug 110.

This electrical power connection adapter 112 has an electrically insulating body 114 with a pair of connective sides 116 and 118. Three standard two-phase, female, electrical connection elements 120, 122 and 124, are mounted to the insulating body 114 at connective side 116 for mating connection with the standard male connectors, or prongs, of the power plug 112. Two other standard, single-phase, male electrical connection elements 126 and 128 are mounted to the body 114 and are accessible for mating connection at connective side 118 with a pair of female connection elements of a standard, single-phase, electrical power receptacle 130 that carry single-phase power from a single-phase power source 131. Two conductive leads 132 and 134 are mounted within the body 114 and respectively directly interconnect, without interruption by circuit breakers, switches or otherwise, the two electrical male connection elements 126 and 128 accessible at connective side 118 with electrical connection elements accessible at connective side 116 that, in turn, are connected to the hot line L and the neutral line N of the single-phase power supply 131. The power line L and the neutral line N of the power supply are thereby connected, respectively, through conductive leads 132 and 134, to the L1 prong 120 and the N prong 122 of the power plug 110 which are respectively connected to the L1 lead and the N lead of the two-phase power cord 108.

The actual transfer of power does not require the presence of a ground connection but standards generally require the presences of a ground connection. Accordingly, the electrical power connection adapter 112 preferably also includes another male connection element 136 mounted to the body 114 and accessible for connection at connection side 118. Another electrical connection element connectable with the ground prong 124 of the power plug 110 is mounted to the body 114 and is accessible at connection side 116. Another conductive lead 138 mounted within the body 114 directly connects, without interruption, the ground line 136 with the female connection element that mates with the ground prong 124 of the power plug 110.

There is a third, female connector at the connection side 116 which is adapted to connect with a standard prong 140 of the power plug 110 that connects with the hot lead L2, but there is no connection of this L2 connector to any of the prongs on the connection side 118. Because this connection does not lead to a connection with the power source 131, from an electrical perspective, if the standard prong 140 of the power plug 110 is removed, there is no need for the mating, third female connector. However, for improved mechanical connection between power plug 110 and the adapter 112 preferably both the standard prong 140 and the mating, third receptacle of the adapter are present and interconnected.

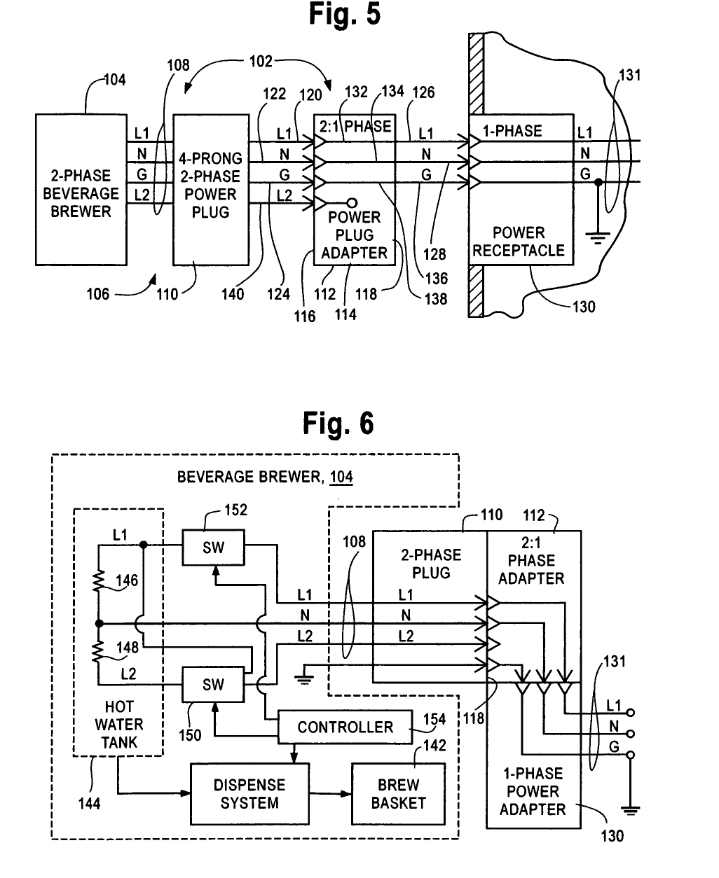

Referring now to FIG. 6, the beverage brewer 104 of FIG. 5 as assembled and connected with the single phase power supply is shown in greater detail. The components of the brewer 104 include a brew basket 142 hot water tank 144 with at least one electrical hot water heating element 146 connected across what would be a two-phase hot line L1 and the neutral line N. The hot line L1 and neutral line N are connected to the single phase power supply hot line L and the neutral line N, respectively, of the single-phase, power supply 131 though interconnections of the power connector adapter 112, the two-phase plug 110 and the two-phase power cord 108.

Preferably, all of the two-phase brewers 104 also have a second electrical heating element 148 that is connected between the second hot line L2 and the neutral line N. This second hot line L2 is not connected to power when the plug 110 is connected through the adapter 112 to the single-phase power supply 131. Thus, absent any change in the circuitry, the second electrical heating element serves no function unless the brewer 104 is connected to a two-phase power supply directly through the two-phase plug 110.

Accordingly, a double-pole, cross-over, switch 150 may be provided in all brewers 104 to optionally disconnect the heating element from the two-phase hot line L2 and instead connect the heating element 148 to the two-phase hot line L1 in parallel with the hot water heating element 146. This is done when the beverage brewer 104 is being powered by a single-phase power supply 131, as shown. The redundancy advantage of having both heating elements 146 and 148 operatively connected is thereby obtained. A separate switch 152 controls the application of power from hot line L1 to both of the heating elements 146 and 148. However, it should be appreciated that the brewer 104 can operate successfully with only one heating element in operation, and thus the presence of the, two-pole, cross-over switch 150 and associated circuitry are optional.

A micro-computer based controller 154 controls the dispense system, the switches 150 and 152 as well as other components such as an alphanumeric display and status lights, and a solenoid controlled water inlet valve, or fill-valve (not shown) to provide unheated water to the tank 144 and the like. Reference should be made to the patents noted above for the details of such components and the other components shown only in functional block form, for such details form no part of the present invention. The controller selectively operates these components in response to pre-programmed parameters, manual inputs and automatic sensory inputs such as inputs from level sensors, temperature sensors and flow meters.

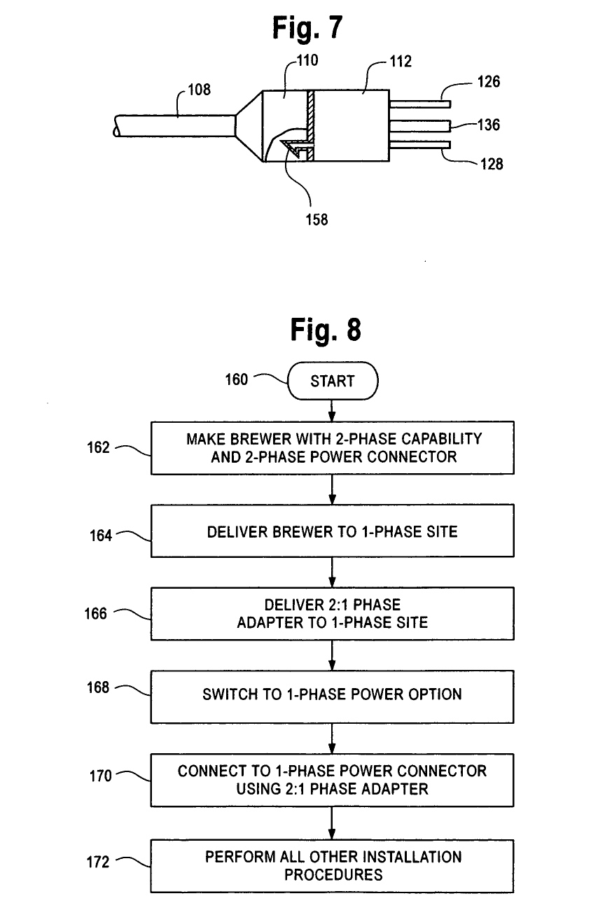

Referring to FIG. 7, during installation, the adapter is preferably fixedly attached to the two-phase power connector by means of at least one of layer of permanent adhesive 156, a mechanical latch 158 or both, to prevent the adapter from being removed and used with another power cord of another apparatus in which the connection provided by the adapter 112 would be unsafe or otherwise inappropriate, such as a clothes dryer or other motorized devices.

Referring now to FIG. 8, a method for installation of electrically powered beverage brewer, such as the two-phase power capable beverage brewer 104 of FIGS. 5 and 6 having an electrical heating element, at an installation site with a single-phase, AC, electrical, power connector providing single-phase, AC, electrical power is illustrated. After the start 160, in step 162, a brewer, such as the brewer 104 of FIG. 6, is manufactured with two-phase power capability. It has at least one, and preferably both, of the electrical heating elements 104 and 108 wired to receive power from a two-phase, AC, power source 131 through a two-phase, the electrical, power cord assembly having a the two-phase power cord 108 and the two-phase, electrical, connector, such as the two-phase power plug 110, for connection to the two-phase, AC, power source 131.

In such case, when connected directly to a two-phase source of power, the first electrical heating element 146 and the second heating element 148 receive electrical power from opposite phases, respectively, of the two-phase power supply appearing on power leads L1 and L2.

Thus, in accordance with the present invention, a method of making a multi-component electrical beverage brewer with electrically powered heating elements is provided by performance of the steps of assembling all components of the beverage brewer to enable successful operation with the heating elements being powered by two-phase, electrical, AC power including a two-phase, electrical, power cord with four leads and an associated two-phase, electrical, power plug with four, outwardly extending, male, electrical connectors respectively electrically connected to the four leads of the electrical power cord and then attaching a power plug adapter to the electrical power plug to enable three of the four, male, electrical, connectors to be connected to a single-phase, electrical, source through a standard, single-phase, plug receptacle to enable at least one of the electrical heating elements to be powered by single-phase, electrical, AC power.

In step 164, the two-phase brewer is delivered to a single-phase power installation site with a source of single-phase power. In step 166, the two-phase to single-phase adapter 112 is delivered to the same single-phase power site to which the brewer 108 was delivered in step 164.

In step 168, the cross-over switch 150, if provided, is actuated to connect the heating element 148 in parallel circuit with the heating element 146 across the first two-phase hot line L1 and the neutral line N of the internal wiring that connects the leads of the cable 108 to the heating elements. The brewer may be delivered either with the second heating element 148 connected to receive power from the two-phase power source 131 or with the second heating element wired to not receive power from the single-phase power source, depending upon the position or other setting of the cross-over switch 150. In lieu of the switch, appropriate connection changes may be made at a connection terminal strip with screw fasteners or with the use of preformed jumpers. However, the cross-over switch is preferred to reduce the chance of an installer making an incorrect connection.

In step 170, a single-phase power connector, such as the standard, single-phase power receptacle 130 of FIG. 6, is connected to the single-phase power source side 118 of the two-phase to single-phase adapter 112, and the brewer side 116 of the adapter 112 is connected to the two-phase, electrical, plug connector 110. After the single-phase power connector 110 has been connected to the single-phase power source 131 using the two-to-one phase adapter 112, the installation is completed. Completion is achieved by passing AC, single-phase, electrical power from the single-phase, power source 131 though the adapter 112 and the two-phase, electrical, power cord assembly to the electrical heating element 146, or both elements 146 and 148, to determine successful operability of the beverage brewer 104.

Finally, the installation is completed in step 172 by performing any other installation procedures that may be needed, if any, such as setting temperature parameters, dispense quantity parameters and dispense timing parameters, and otherwise making sure that the brewer is fully functional as intended. If no other steps are required in step 172, because adapting the power cord for connection to a single-phase power source is so relatively simple as compared to changing the entire power cord assembly, the installation is complete at step 170 and may be completed solely by the end user without the assistance of a professional installer

These steps need not be performed sequentially in the order given. For instance, the adapter 112 may be delivered to the customer location packaged together with the brewer, may be separately delivered or, if there is a professional installer, may be routinely carried by the installer and delivered by the installer a the time of installation.

In addition, it should be appreciated that upon receipt of an order for a one-phase brewer, in lieu of steps step 166, 168 and 170 may be substituted with similar steps that are performed at the factory or warehouse in response to an order for a single-phase brewer. In such case, the attachment of the adapter to the two-phase power plug and the actuation of the cross-over switch to connect both heating elements in parallel between the neutral lead N and one of the hot lines L1 or L2 are performed at the factory or warehouse after step 162 but prior to the delivery to the customer site in step 164. However, to eliminate the problem that arises when the customer is mistaken about the need for single-phase power operation, it is preferred to perform the connection of the adapter on site in case the installer discovers that two-phase power is available and the adapter is not needed, for once the adapter is attached to the power plug, it cannot be detached.

Because of the method of constriction of the brewer and the method of installation, a simplified method of inventorying a brewer is provided. This method of inventorying electrically powered beverage brewers is performed by first making an electrically powered beverage brewer model that is capable of operating only with two-phase electrical power, without alteration after completion of manufacture. Assigning only a single (a) a model number, (b) an inventory stock number or (c) a stock keeping brewer number or (d) any inventory control number that uniquely distinguishes the model without reference to the type of power required, and using at least one of the numbers for at least one of (a) inventory control, (b) ordering, (c) selecting a warehouse storage location. Alternatively, or additionally, a second model number may be assigned for purposes of ordering a brewer for single-phase power operation which number is used to control power capability alteration either during installation or immediately prior to shipment. For instance, only one number is used for inventory control because all the models are the same, but when this model is ordered with 120-VAC power capability, the adaption is made prior to shipment, or preferably, the adapter is shipped with the model along with directions to actuate the cross-over switch.

While a particular embodiment has been disclosed in detail, it should be appreciated that changes may be made without departing from the scope and spirit of the invention. For instance, while it is contemplated that the power connector at the end of the power cord attached to the brewer is a plug with three standard two-phase male connectors and a fourth ground connector, the brewer power connector could be a standard two-phase, female, receptacle connector, such that the adapter would be provided with a standard two-phase male connector on one side and a standard single-phase male connector on the other connection side. Likewise, if needed, both of the connectors on opposite sides of the adapter could be both female connectors. Although the adapter is shown with the connectors on opposite sides, the adapter connectors could be mounted on adjacent sides. Although, it is desired to permanently affix the adapter to the brewer plug to avoid the risks of improper use with other than the brewer, such permanent attachment is not necessary for successful operation. Likewise, although some advantages would be lost if the two heating element were not provided, or if the second heating element were not reconfigured for single phase use, operation with only one heating element in circuit can be achieved. Although, the two heating elements are shown connected to opposite phases of the power they could also be connected across the opposite phases either directly or though a transformer. Other variations will occur to those skilled in the art.

1. A method of inventorying electrically powered beverage brewers, comprising the steps of:
making an electrically powered beverage brewer model that is capable of operating with either single-phase electrical power or two-phase electrical power, without alteration after completion of manufacture, though selective use of a power connection adapter; and
assigning only a single one of one of (a) a model number, (b) an inventory stock number or (c) a stock keeping unit number or (d) any inventory control number that uniquely distinguishes the model without reference to the type of power required.
using at least one of the numbers for at least one of (a) inventory control, (b) ordering, (c) selecting a warehouse storage location.

2. The inventorying method of claim 1 in which the power connector adapter is a plug adapter with three male connectors for connection with a standard single-phase, electrical, AC, power supply receptacle and four female connectors for connection to four male connectors of a standard two-phase, AC, power plug.

3. The inventorying method of claim 2 in which the beverage brewer includes two electrical, hot water, heating elements commonly connected to a neutral male connector of the two-phase power plug and respectively connected to two power carrying male connectors of the power plug.

4. The inventorying method of claim 2 in which the adapter carries means for permanently attachment to the power plug.

5. The inventorying method of claim 1 including the step of packaging the adapter together with the beverage brewer.

6. The inventorying method of claim 1 in which only a single model number is assigned to the electrically powered beverage brewer model.

7. The inventorying method of claim 1 in which only a single stock number is assigned to the electrically powered beverage brewer.

8. The inventorying method of claim 1 in which only a single stock keeping number is assigned to the electrically powered beverage brewer.

9. The inventorying method of claim 1 in which only a single inventory control number is assigned to the electrically powered beverage brewer.

10. The inventorying method of claim 1 in which the at least one of the numbers is used for inventory control.

11. The inventorying method of claim 1 in which the at least one of the numbers is used for ordering the brewer model.

12. The inventorying method of claim 1 in which the at least one of the numbers is used for selecting a warehouse storage location for the brewer model.

13. The inventorying method of claim 1 in which the brewer model has a two phase power capability and has an attached two phase power connector plug.

14. The inventorying method of claim 13 in which the brewer model includes a two-phase to one-phase power plug adapter selectively connectable to the two phase power plug for conversion for use with single phase power.

15. The inventorying method of claim 14 in which the brewer model has two heating elements and a switch for selectively connecting the heating elements to either the same side of a two phase power line or to opposite sides of the two-phase power line.

16. The inventorying method of claim 1 in which the brewer model includes a two-phase to one-phase power plug adapter selectively connectable to the two phase power plug for conversion for use with single phase power.

17. The inventorying method of claim 15 in which the brewer model has two heating elements and a switch for selectively connecting the heating elements to either the same side of a two phase power line or to opposite sides of the two-phase power line.

18. The inventory method of claim 1 including the step of providing a separate inventory control number to the power plug adapter.
